(19) United States
(12) Patent Application Publication
(10) Pub. No.: US 2017/0053622 A1
(43) Pub. Date: Feb. 23, 2017

(54) METHOD AND APPARATUS FOR SETTING TRANSPARENCY OF SCREEN MENU, AND AUDIO AND VIDEO PLAYING DEVICE

(71) Applicants: LE HOLDINGS (BEIJING) CO., LTD., Beijing (CN); LE SHI ZHI XIN ELECTRONIC TECHNOLOGY (TIAN JIN) LIMITED, Tianjin (CN)

(72) Inventor: Wei LIU, Tianjin (CN)

(21) Appl. No.: 15/242,069

(22) Filed: Aug. 19, 2016

Related U.S. Application Data
(63) Continuation of application No. PCT/CN2016/082403, filed on May 17, 2016.

(30) Foreign Application Priority Data
Aug. 21, 2015 (CN) 201510522166.4

(51) Int. Cl. G09G 5/377

(52) U.S. Cl. CPC G09G 5/377; G06F 2203/04804; G06F 3/0482

(57) ABSTRACT

Embodiments of the present application provide a method and apparatus for setting transparency of a screen menu, an audio and video playing device, and a non-transitory computer-readable storage medium, and the method includes: receiving screen menu data; and presetting the transparency of an area to be adjusted in the received screen menu data to a preset transparency, and superimposing a received external video signal onto the screen menu data in which the transparency is set, and transmitting the superimposed data to a display screen for displaying, wherein the preset transparency is other transparency than opacity. With this method, the transparency of the background in the received screen menu data is set to the preset transparency, and the received external video signal is superimposed onto the screen menu data in which the transparency of the background is set, and transmitted to the display screen for displaying, so that the external video signal superimposed onto the screen menu data can be displayed by displaying the screen menu in the at least semi-transparent background, so that a user can see the external video signal shielded by the background of the screen menu, thus improving the experience of the user.

### CROSS REFERENCE TO RELATED APPLICATIONS

This application is a continuation application of International Application PCT/CN2016/082403, filed on May 17, 2016, which claims the benefit of Chinese Patent Application No. 201510522166.4, filed with the Chinese Patent Office on Aug. 21, 2015 and entitled “A method and apparatus for setting the transparency of a screen menu, and an audio and video playing device”, which is hereby incorporated by reference in its entirety.

### TECHNICAL FIELD

Embodiments of the present application relate to the field of multimedia technologies, and more particularly to a method and apparatus for setting transparency of a screen menu, and an audio and video playing device.

### BACKGROUND

An intelligent video processor in an existing device for playing audio and video (e.g., an intelligent TV set) can superimpose a video signal onto screen menu data, and transmit them to a display screen for displaying, and can set transparency of a screen menu by setting Alpha data in a V-by-One format, that is, the Alpha data in the V-by-One format is configured to set the transparency of a background of the screen menu. However, the user requirement is usually difficult to meet due to the lower processing capacity of the processor in the existing audio and video playing device (i.e., an intelligent TV set).

A clock frequency of, and the number of bits in a register, in the processor of some high-performance audio and video playing device, e.g., a computer, a mobile phone, etc., are higher and more than a general processor (for example, the number of bits in a register in the general processor is 32 bits, and an operating frequency of the general processor is 1.2 GHz, whereas the number of bits in the register in the processor of the high-performance audio and video playing device is 64 bits, and an operating frequency of the processor is 2 to 2.5 GHz as opposed thereto), so the processor of the high-performance audio and video playing device has a more capacity of playing a high-definition video or running large game. However in such an audio and video playing device, if an external video signal is superimposed by a chip external to the processor of the high-performance audio and video playing device onto screen menu data output by the high-performance audio and video playing device, the Alpha data are not set in the standard High Definition Multimedia Interface (HDMI) format in which the screen menu data displayed while displaying the external video signal superimposed on the screen menu data, so that the user may not see the external video signal shielded by the background of the screen menu, thus degrading the experience of the user.

### SUMMARY

Embodiments of the present application provide a method and apparatus for setting transparency of a screen menu, an audio and video playing device, and a non-transitory computer-readable storage medium so as to address such a problem in the existing high-performance audio and video playing device that if the external video signal is superimposed onto the screen menu data by the chip external to the processor of the high-performance audio and video playing device, the transparency of the background of the screen menu may not be set, thus degrading the experience of the user.

An embodiment of the present application provides a method for setting transparency of a screen menu, the method including: receiving, by an audio and video playing device, screen menu data; and setting, by the audio and video playing device, transparency of an area to be adjusted in the received screen menu data to a preset transparency, and superimposing, by the audio and video playing device, a received external video signal onto the screen menu data in which the transparency is set, and transmitting, by the audio and video playing device, the superimposed data to a display screen for displaying, wherein the preset transparency is a transparency other than opacity.

An embodiment of the present application provides an apparatus for setting transparency of a screen menu, the apparatus including: a receiving module configured to receive screen menu data; and a setting and superimposing module configured to set transparency of an area to be adjusted in the received screen menu data to a preset transparency, and superimpose a received external video signal onto the screen menu data in which the transparency is set, and transmit the superimposed data to a display screen for displaying, wherein the preset transparency is a transparency other than opacity.

An embodiment of the present application provides an audio and video playing device including a processor, a Frame Rate Conversion/Motion Estimation and Motion Compensation (FRC/MEMC) chip, and a display, wherein the processor is configured to set transparency of an area to be adjusted in screen menu data to a preset transparency, and transmit the screen menu data in which the transparency has been set, to the FRC/MEMC chip; and the FRC/MEMC chip is configured to superimpose a received external video signal onto the screen menu data, in which the transparency has been set, and transmit the superimposed data to the display for displaying, wherein the preset transparency is a transparency other than opacity.

An embodiment of the present application provides an audio and video playing device including a processor, a video format conversion chip, and a display, wherein the processor is configured to set transparency of an area to be adjusted in screen menu data to a preset transparency, and transmit the screen menu data, in which the transparency has been set, to the video format conversion chip; and the video format conversion chip is configured to superimpose a received external video signal onto the screen menu data in which the transparency has been set, and transmit the superimposed data to the display for displaying, wherein the preset transparency is a transparency other than opacity.

An embodiment of the present application provides an audio and video playing device including at least one processor; and a memory communicably connected with the at least one processor for storing instructions executable by the at least one processor, wherein execution of the instructions by the at least one processor causes the at least one processor to: receive screen menu data; and set the transparency of an area to be adjusted in the received screen menu data to a preset transparency, superimpose a received external video signal onto the screen menu data in which the transparency has been set, and transmit the superimposed data to a display screen for displaying, wherein the preset transparency is a transparency other than opacity.

An embodiment of the present application provides a non-transitory computer-readable storage medium storing executable instructions that, when executed by an electronic device with a touch-sensitive display, cause the electronic device to perform the method for setting transparency of a screen menu according to the embodiment above of the present application.

With the method and apparatus for setting the transparency of a screen menu, the audio and video playing device, and the non-transitory computer-readable storage medium according to the embodiments of the present application, the transparency of the area to be adjusted in the received screen menu data is set to the preset transparency, and the received external video signal is superimposed onto the screen menu data in which the transparency is set, and the superimposed data are transmitted to the display screen for displaying, so that the external video signal superimposed onto the screen menu data can be displayed by displaying the at least semitransparent screen menu if the area to be adjusted is the menu area, so that the user can see the external video signal shielded by the screen menu, thus improving the experience of the user.

### BRIEF DESCRIPTION OF THE DRAWINGS

In order to make the technical solutions according to the embodiments of the present application or in the prior art more apparent, the drawings to which a description of the embodiments or the prior art refers will be briefly introduced below, and apparently the drawings to be described below are merely illustrative of some of the embodiments of the present application, and those ordinarily skilled in the art can derive from these drawings other drawings without any inventive effort.

One or more embodiments are illustrated by way of example, and not by limitation, in the figures of the accompanying drawings, wherein elements having the same reference numeral designations represent like elements throughout. The drawings are not to scale, unless otherwise disclosed. In the drawings:

FIG. 1 is a first flow chart of a method for setting transparency of a screen menu according to some embodiments of the present application;

FIG. 2 is a schematic diagram of a screen menu displayed in accordance with screen menu data according to some embodiments of the present application;

FIG. 3 is a second flow chart of a method for setting transparency of a screen menu according to some embodiments of the present application;

FIG. 4 is a schematic structural diagram of a first application scenario of a method for setting transparency of a screen menu according to some embodiments of the present application;

FIG. 5 is a schematic structural diagram of a second application scenario of a method for setting the transparency of a screen menu according to some embodiments of the present application; and

FIG. 6 is a schematic structural diagram of an apparatus for setting transparency of a screen menu according to some embodiments of the present application;

FIG. 7 is a schematic structural diagram of an audio and video playing device according to some embodiments of the present application.

### DETAILED DESCRIPTION

In order to make the objects, technical solutions, and advantages of the embodiments of the present application more apparent, the technical solutions according to the embodiments of the present application will be described below clearly and fully with reference to the drawings in the embodiments of the present application, and apparently the embodiments described below are only a part but not all of the embodiments of the present application. Based upon the embodiments here of the present application, all the other embodiments which can occur to those skilled in the art without any inventive effort shall fall into the scope of the present application.

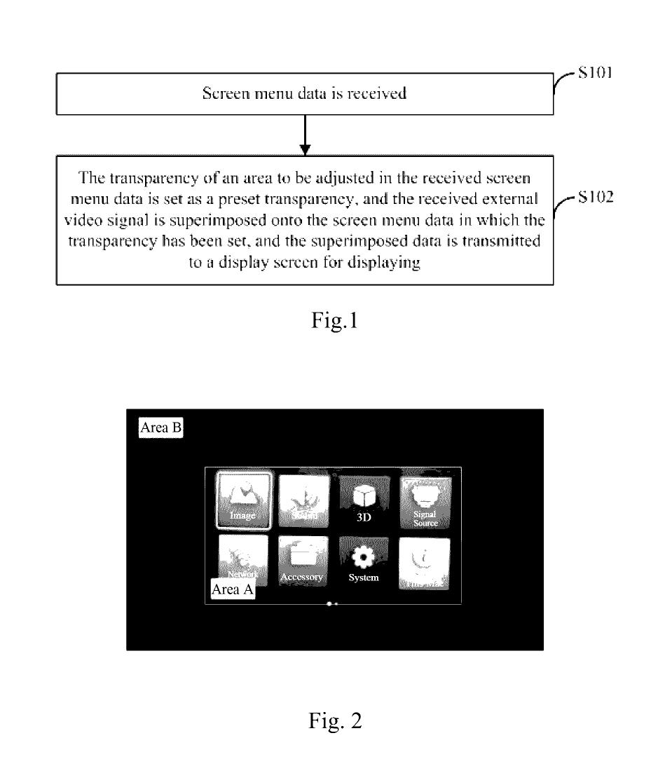

As illustrated in FIG. 1, a method for setting transparency of a screen menu according to an embodiment of the present application includes the following steps:

In the step S101, screen menu data is received.

In the step S102, the transparency of an area to be adjusted in the received screen menu data is set as a preset transparency, and the received external video signal is superimposed onto the screen menu data in which the transparency has been set, and the superimposed data is transmitted to a display screen for displaying.

Herein, the preset transparency is a transparency other than opacity.

Thus if the area to be adjusted is a menu area, the screen menu displayed on the display screen has certain transparency without shielding all the displayed external video signals, thus improving the experience of a user.

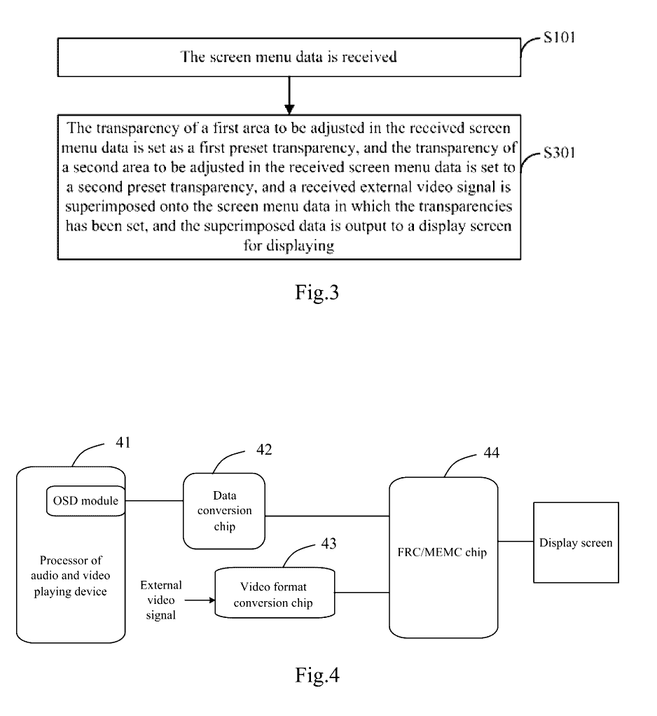

FIG. 2 is a schematic diagram of a screen menu, and as can be apparent from FIG. 2, a menu displayed according to screen menu data typically includes two areas, i.e., an area A defined by the white line, and an area B beyond the white line, where the area A is different from the area B in that there are menu options and the background in the area A, and there is only the background in the area B. Thus the color of the background in the area A can be set to a first color so as to define the area A as a first area to be adjusted, and the color of the background in the area B can be set to a second color so as to define the area B as a second area to be adjusted, whereby a method for setting transparency of a screen menu according to an embodiment of the present application includes the following steps as illustrated in FIG. 3:

In the step S101, the screen menu data is received.

In the step S301, the transparency of a first area to be adjusted in the received screen menu data is set as a first preset transparency, and the transparency of a second area to be adjusted in the received screen menu data are set to a second preset transparency, and a received external video signal is superimposed onto the screen menu data in which the transparencies has been set, and the superimposed data are output to a display screen for displaying, where both the first preset transparency and the second preset transparency are transparencies other than opacity.

Since there are menu options in the area A, the transparency of the area A, i.e., the first area to be adjusted in the screen menu data can be set to the first preset transparency which is a transparency other than total transparency and opacity, i.e., a semi-transparency, where the transparency is set to an Alpha value at levels 0 to 255 with 0 representing total transparency, and 255 representing opacity, so the Alpha value of the semi-transparency lies between 0 and 255. Since the area A is semi-transparent, a video displayed according to the external video signal can be seen through the area A.

Here since there are no menu options in the area B, the transparency of the area B, i.e., the second area to be adjusted in the screen menu data can be set to the second preset transparency which can be total transparency, so the video displayed according to the external video signal can be seen through the area B.

Here the first area to be adjusted is a menu area in the screen menu data, and the second area to be adjusted is an image area other than the menu area in the screen menu data.

If a method for setting transparency of a screen menu according to an embodiment of the present application is applied in reality, an application scenario of this method can be as illustrated in the schematic structural diagram in FIG. 4, where screen menu data can be output by a processor 41 of an audio and video playing device in any data format, e.g., the HDMI format, and On-Screen Display (OSD) data output by the processor 41 of the audio and video playing device can be converted by a data conversion chip 42 into OSD data that can be identified by a Frame Rate Conversion/Motion Estimation and Motion Compensation (FRC/MEMC) chip 44, and a video format conversion chip 43 can convert a received external video signal in any format into a video signal that can be recognized by the FRC/MEMC chip 44, for example, if the FRC/MEMC chip 44 can identify a video signal in the V-by-One format, the video format conversion chip 43 will convert a received external video signal in some format, e.g., the HDMI format, into a video signal in the V-by-One format, and output it to the FRC/MEMC chip 44. The FRC/MEMC chip 44 sets the transparency of an area to be adjusted in the received OSD data to a preset transparency, superimposes the external video signal converted in format by the video format conversion chip 43 onto the OSD data in which the transparency is set, and outputs the superimposed data to a display screen for displaying. Alternatively if the color of the background of a first area to be adjusted, i.e., a menu area, in the OSD data received by the FRC/MEMC chip 44 is a first color, and the color of the background of other area than the menu area, i.e., a second area to be adjusted, is a second color, the FRC/MEMC chip 44 will set the transparency of the first area to be adjusted in the received OSD data to a first preset transparency, and the transparency of the second area to be adjusted in the received OSD data to a second preset transparency, superimpose the external video signal converted in format by the video format conversion chip 43 onto the OSD data in which the transparencies of the background are set, and output the superimposed data to the display screen for displaying.

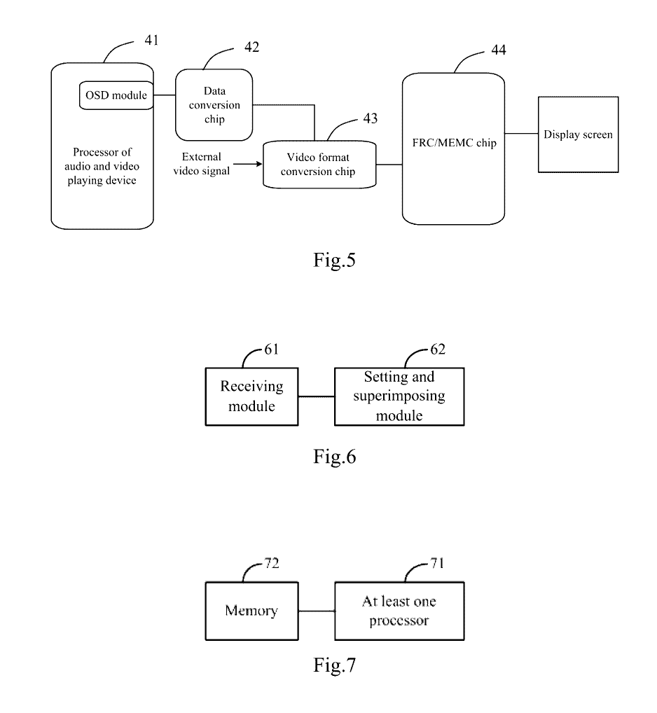

If a method for setting transparency of a screen menu according to an embodiment of the present application is applied in reality, an application scenario of this method can be as illustrated in the schematic structural diagram in FIG. 5, where screen menu data can be output by a processor 41 of an audio and video playing device in any data format, e.g., the HDMI format, and OSD data output by the processor 41 of the audio and video playing device can be converted by a data conversion chip 42 into OSD data that can be identified by a video format conversion chip 43. The video format conversion chip 43 sets the transparency of an area to be adjusted in the received OSD data to a preset transparency, superimposes a received external video signal onto the OSD data in which the transparency is set, and converts the video signal superimposed onto the OSD data into a video signal that can be identified by an FRC/MEMC chip 44. Alternatively the color of the background of a first area to be adjusted, i.e., a menu area, in the OSD data received by the video format conversion chip 43 is a first color, and the color of the background of other area than the menu area, i.e., a second area to be adjusted, is a second color, the video format conversion chip 43 will set the transparency of the first area to be adjusted in the received OSD data to a first preset transparency, and the transparency of the second area to be adjusted in the received OSD data to a second preset transparency, superimpose the received external video signal onto the OSD data in which the transparencies are set, and convert the video signal superimposed onto the OSD data into a video signal that can be identified by the FRC/MEMC chip 44. For example, if the FRC/MEMC chip 44 can identify a video signal in the V-by-One format, the video format conversion chip 43 will convert an external video signal in some format, e.g., the HDMI format, into a video signal in the V-by-One format, and output it to the FRC/MEMC chip 44. The FRC/MEMC chip 44 compensates for and output the received video signal to a display screen for displaying.

Here the processor of the audio and video playing device can be connected with an Ethernet module, a Wireless Fidelity (WiFi) module, a Bluetooth module, a power management module, a storage module, an audio system, etc.

That is, if the external video signal is superimposed by a chip onto the OSD data output by the processor of the audio and video playing device, the transparency of the area to be adjusted in the OSD data will be set by this chip. The external video signal above refers to a video signal output by an externally connected video signal source instead of a video signal output by the processor of the audio and video playing device.

Based upon the same inventive concept, an embodiment of the present application further provides an apparatus for setting the transparency of a screen menu, and since the apparatus addresses the problem under a similar principle to the method above for setting the transparency of a screen menu, reference can be made to the implementation of the method above for an implementation of the apparatus, and a repeated description thereof will be omitted here.

As illustrated in FIG. 6, an apparatus for setting transparency of a screen menu according to an embodiment of the present application includes:

A receiving module 61 is configured to receive screen menu data; and

A setting and superimposing module 62 is configured to set transparency of an area to be adjusted in the received screen menu data to a preset transparency, and superimpose a received external video signal onto the screen menu data in which the transparency is set, and transmit the superimposed data to a display screen for displaying;

Where the preset transparency is a transparency other than opacity.

Preferably the setting and superimposing module 62 is configured to:

Set transparency of a first area to be adjusted in the received screen menu data to a first preset transparency, and transparency of a second area to be adjusted in the received screen menu data to a second preset transparency, and superimpose the received external video signal onto the screen menu data in which the transparencies are set, and output the superimposed data to the display screen for displaying, where both the first preset transparency and the second preset transparency are transparencies other than opacity.

Here the first preset transparency is a transparency other than total transparency, and the second preset transparency is total transparency.

The first area to be adjusted is a menu area, and the second area to be adjusted is an image area other than the menu area.

If the method for setting transparency of a screen menu according to the embodiment of the present application is applied in the scenario illustrated in FIG. 4, an embodiment of the present application further provides an FRC/MEMC chip including an FRC/MEMC module, and an image superimposing module including the apparatus for setting transparency of a screen menu according to the embodiment of the present application.

If the method for setting transparency of a screen menu according to the embodiment of the present application is applied in the scenario illustrated in FIG. 5, an embodiment of the present application further provides a video format converting chip including a data format conversion module, and an image superimposing module including the apparatus for setting transparency of a screen menu according to the embodiment of the present application.

An embodiment of the present application provides an audio and video playing device including a processor, a Frame Rate Conversion/Motion Estimation and Motion Compensation (FRC/MEMC) chip, and a display, where the processor is configured to set transparency of an area to be adjusted in screen menu data to a preset transparency, and transmit the screen menu data, in which the transparency has been set, to the FRC/MEMC chip; and the FRC/MEMC chip is configured to superimpose a received external video signal onto the screen menu data in which the transparency has been set, and transmit the superimposed data to the display for displaying, where the preset transparency is a transparency other than opacity.

In a possible implementation of the audio and video playing device according to the embodiment of the present application, the processor is configured to: set transparency of a first area to be adjusted in the screen menu data to a first preset transparency, and transparency of a second area to be adjusted in the screen menu data to a second preset transparency, and transmit the screen menu data in which the transparencies are set to the FRC/MEMC chip, where both the first preset transparency and the second preset transparency are transparencies other than opacity.

In a possible implementation of the audio and video playing device according to the embodiment of the present application, the first preset transparency is a transparency other than total transparency, and the second preset transparency is total transparency.

An embodiment of the present application provides an audio and video playing device including a processor, a video format conversion chip, and a display, where the processor is configured to set transparency of an area to be adjusted in screen menu data to a preset transparency, and transmit the screen menu data, in which the transparency has been set, to the video format conversion chip; and the video format conversion chip is configured to superimpose a received external video signal onto the screen menu data in which the transparency has been set, and transmit the superimposed data to the display for displaying, where the preset transparency is a transparency other than opacity.

In a possible implementation of the audio and video playing device according to the embodiment of the present application, the processor is configured to: set transparency of a first area to be adjusted in the screen menu data to a first preset transparency, and set transparency of a second area to be adjusted in the screen menu data to a second preset transparency, and transmit the screen menu data, in which transparencies has been set, to the video format conversion chip, where both the first preset transparency and the second preset transparency are transparencies other than opacity.

In a possible implementation of the audio and video playing device according to the embodiment of the present application, the first preset transparency is a transparency other than total transparency, and the second preset transparency is total transparency.

As illustrated in FIG. 7, an audio and video playing device including at least one processor 71; and a memory 72 communicably connected with the at least one processor for storing instructions executable by the at least one processor 71, wherein execution of the instructions by the at least one processor 71 causes the at least one processor 71 to: receive screen menu data; and set transparency of an area to be adjusted in the received screen menu data to a preset transparency, superimpose a received external video signal onto the screen menu data in which the transparency has been set, and transmit the superimposed data to a display screen for displaying, where the preset transparency is a transparency other than opacity.

In a possible implementation of the audio and video playing device according to the embodiment of the present application, the execution of the instructions by the at least one processor further causes the at least one processor to: set transparency of a first area to be adjusted in the received screen menu data to a first preset transparency, and set transparency of a second area to be adjusted in the received screen menu data to a second preset transparency, where both the first preset transparency and the second preset transparency are transparencies other than opacity.

In a possible implementation of the audio and video playing device according to the embodiment of the present application, the first preset transparency stored in the memory is transparency other than total transparency.

In a possible implementation of the audio and video playing device according to the embodiment of the present application, the second preset transparency stored in the memory is total transparency.

In a possible implementation of the audio and video playing device according to the embodiment of the present application, the first preset transparency stored in the memory is a menu area, and the second preset transparency stored in the memory is an image area other than the menu area.

An embodiment of the present application provides A non-transitory computer-readable storage medium storing executable instructions that, when executed by an electronic device with a touch-sensitive display, cause the electronic device to perform the method for setting transparency of a screen menu according to the embodiment above of the present application.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the present application. This can be understood and practiced by those ordinarily skilled in the art without any inventive effort.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the present application; and although the present application has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the present application as claimed.

What is claimed is:

1. A method for setting transparency of a screen menu, which is applied by an audio and video playing device, comprising:
receiving screen menu data; and
setting transparency of an area to be adjusted in the received screen menu data to a preset transparency, and superimposing a received external video signal onto the screen menu data in which the transparency is set, and transmitting the superimposed data to a display screen for displaying;
wherein the preset transparency is a transparency other than opacity.

2. The method according to claim 1, wherein the setting the transparency of the area to be adjusted in the received screen menu data to the preset transparency comprises:
setting transparency of a first area to be adjusted in the received screen menu data to a first preset transparency, and transparency of a second area to be adjusted in the received screen menu data to a second preset transparency;
wherein both the first preset transparency and the second preset transparency are transparencies than opacity.

3. The method according to claim 2, wherein the first preset transparency is transparency other than total transparency.

4. The method according to claim 2, wherein the second preset transparency is total transparency.

5. The method according to claim 2, wherein the first area to be adjusted is a menu area, and the second area to be adjusted is an image area other than the menu area.

6. An audio and video playing device, comprising a processor, a Frame Rate Conversion/Motion Estimation and Motion Compensation (FRC/MEMC) chip, and a display, wherein:
the processor is configured to set transparency of an area to be adjusted in screen menu data to a preset transparency, and transmit the screen menu data, in which the transparency has been set, to the FRC/MEMC chip; and
the FRC/MEMC chip is configured to superimpose a received external video signal onto the screen menu data in which the transparency has been set, and transmit the superimposed data to the display for displaying;
wherein the preset transparency is a transparency other than opacity.

7. The audio and video playing device according to claim 6, wherein the processor is further configured to:
set transparency of a first area to be adjusted in the screen menu data to a first preset transparency, and transparency of a second area to be adjusted in the screen menu data to a second preset transparency, and transmit the screen menu data in which the transparencies are set to the FRC/MEMC chip;
wherein both the first preset transparency and the second preset transparency are transparencies than opacity.

8. The audio and video playing device according to claim 7, wherein the first preset transparency is transparency other than total transparency, and the second preset transparency is total transparency; and the first area to be adjusted is a menu area, and the second area to be adjusted is an image area other than the menu area.

9. An audio and video playing device, comprising a processor, a video format conversion chip, and a display, wherein:
the processor is configured to set transparency of an area to be adjusted in screen menu data to a preset transparency, and transmit the screen menu data, in which the transparency has been set, to the video format conversion chip; and
the video format conversion chip is configured to superimpose a received external video signal onto the screen menu data in which the transparency has been set, and transmit the superimposed data to the display for displaying;
wherein the preset transparency is a transparency other than opacity.

10. The audio and video playing device according to claim 9, wherein the processor is further configured to:
set transparency of a first area to be adjusted in the screen menu data to a first preset transparency, and set transparency of a second area to be adjusted in the screen menu data to a second preset transparency, and transmit the screen menu data, in which the transparencies have been set, to the video format conversion chip;
wherein both the first preset transparency and the second preset transparency are transparencies other than opacity.

11. The audio and video playing device according to claim 10, wherein the first preset transparency is transparency other than total transparency, and the second preset transparency is total transparency; and the first area to be adjusted is a menu area, and the second area to be adjusted is an image area other than the menu area.

12. An audio and video playing device, comprising at least one processor; and a memory communicably connected with the at least one processor for storing instructions executable by the at least one processor, wherein execution of the instructions by the at least one processor causes the at least one processor to:
receive screen menu data; and set transparency of an area to be adjusted in the received screen menu data to a preset transparency, superimpose a received external video signal onto the screen menu data in which the transparency has been set, and transmit the superimposed data to a display screen for displaying, wherein the preset transparency is a transparency other than opacity.

13. The audio and video playing device according to claim 12, wherein the execution of the instructions by the at least one processor further causes the at least one processor to:
set transparency of a first area to be adjusted in the received screen menu data to a first preset transparency, and set transparency of a second area to be adjusted in the received screen menu data to a second preset transparency;
wherein both the first preset transparency and the second preset transparency are transparencies other than opacity.

14. The audio and video playing device according to claim 13, wherein the first preset transparency stored in the memory is transparency other than total transparency.

15. The audio and video playing device according to claim 13, wherein the second preset transparency stored in the memory is total transparency.

16. The audio and video playing device according to claim 13, wherein the first preset transparency stored in the memory is a menu area, and the second preset transparency stored in the memory is an image area other than the menu area.
